(19) United States
(12) Patent Application Publication
(10) Pub. No.: US 2003/0003794 A1
(43) Pub. Date: Jan. 2, 2003

(54) Telecommunications backbone junction module and distribution point

(76) Inventors: Hans-Dieter Otto, Wipperfurth (DE); Friedhelm Denter, Castrop-Rauxel (DE); Norbert Gaertner, Wuppertal (DE); Klaus-Dieter Burmeister, Wuppertal (DE); Claudia Burmeister, Wuppertal (DE)

Correspondence Address: Finnegan, Henderson, Farabow,, Garrett & Dunner, L.L.P., 1300 I Street, N.W., Washington, DC, 20005-3315, US

(21) Appl. No.: 10/153,811

(22) Filed: May 24, 2002

Related U.S. Application Data
(63) Continuation of application No. PCT/EP00/11731, filed on Nov. 24, 2000.

(30) Foreign Application Priority Data
Nov. 25, 1999 (DE) 299 20 712.9

(51) Int. Cl. H01R 4/24

(52) U.S. Cl. 439/404

(57) ABSTRACT

A telecommunications backbone junction module (10) is configured in the form of a cable connector for mounting in a telecommunications rack-mounting system and comprises through-contact elements for joining, particularly prefabricated, conductors of a backbone cable (12) on the one hand, and, on the other, IDC contacts in a front portion in the mounting position for joining the patching cables (14).

### TECHNICAL FIELD

The invention relates to a telecommunications backbone junction module for joining the conductors of a backbone cable, on the one hand, and patching cables, on the other.

A telecommunications distribution point is typically two-sided in function, it comprising namely the line side for receiving the so-called line cables leading to the individual telecommunications extensions and the backbone side serving to join the backbone cable leading to the exchanges (offices) or other facilities as necessary. Formed between the line and backbone modules are patch panels to flexibly interconnect the cabling on both sides according to requirements.

### PRIOR ART

Numerous prior art junction blocks are known suitable for use both as line and backbone junction modules. In addition, systems termed “RXS” are on the market in which the so-called backbone cables leading from the exchanges and the like to the backboard junction modules are prefabricated with connectors so that the connectors can be plugged into the backboard junction modules, resulting in the conductors of the backbone cable being connected to the contacts of the junction module to which the patching cables can be joined.

Known from EP 0 765 091 A2 is a modular multiple junction block whose line and backbone junction blocks can be prefabricated with the corresponding conductors and rack-mounted stacked, thus resulting in a multiple junction block having no segregation of the line side from the backbone side. Accordingly, patching cables can only be joined for special instances. The connection between the line and backbone sides of the system as described is typically made by a simple jumper extending from one junction module to the next. Provided at the rear side of the backbone junction block are contacts for tapping overvoltage protection components.

### SUMMARY OF THE INVENTION

The invention is based on the object of providing a telecommunications backbone junction module of simple configuration satisfying the backbone requirements with minimum expenditure whilst permitting segregation between line and backbone components in the distribution point in which it is incorporated. This object is achieved by the junction module as it reads from claim 1.

As it reads from claim 1 the junction module in accordance with the invention directly takes the form of a cable connector so that the novel junction module can be prefabricated with the conductors of the backbone cable. In other words, the junction module in accordance with the invention corresponds to a conventional junction module since it can be directly mounted in a telecommunications rack mounting system whilst forming a cable connector since it can be provided prefabricated in terminating a backbone cable. Unlike known RXS cable connectors the cable connector in accordance with the invention is not plugged into a separate junction module, it instead already forming to a certain extent the junction module for mounting in the rack mounting system for componenting with the patching cables on plugging the cable connector into the rack mounting system.

In accordance with the invention it is furthermore provided for that the cable connector forming the junction module comprises through-contact elements, i.e. providing neither a breakpoint nor a tap for overvoltage protection. This thus reduces the backbone junction module to the essential elements and unlike, for example, the subject matter of the aforementioned EP 0 765 091 comprises no additional features such as breakpoints and overvoltage protection taps. The through-contact elements as described permit a single-row configuration as regards the terminal contacts which more particularly comprise in a front portion a row of IDC contacts in the mounting position to which the patching cables can each be joined.

Unlike a conventional junction module in which the conductors of the backbone cable coming from the exchanges (offices) are likewise connected to the front side this is now possible in the junction module in accordance with the invention configured as a cable connector at the rear side so that the overall size of the junction module is reduced and the space required for the backbone side of the distribution point can be reduced to advantage. In conclusion, the junction module in accordance with the invention does away with backbone mounting, as it is called. The invention thus provides for a small junction module of simple configuration which especially makes for less field expenditure whilst satisfying requirements. As an alternative it is also conceivable to join the conductors of the backbone cable to the cable connector in accordance with the invention in the field by making use of a suitable tool so that in this embodiment of the invention too, it provides a compact cable connector in keeping with requirements for use as a junction module.

Preferred aspects of the invention read from the further claims.

It is good practice to design the junction module split with a so-called cable junction portion being provided for joining the conductors of the backbone cable, this cable junction portion being connectable via suitable contacts to a so-called receiving portion for patching contacts serving to join the patching cables. Independent of the receiving portion in this arrangement at least the cable junction portion can be prefabricated as the termination of a backbone cable.

For the case as described above the cable junction portion is preferably mountable in a telecommunications rack mounting system, and the receiving portion is mounted—particularly from the front—on the cable junction portion. This arrangement reduces the element, serving to join the patching cables, to a module having a single row of contacts for plugging into the prefabricated juction portion via suitable contacts.

The advantages of the junction module in accordance with the invention are achievable to a great extent by componenting a telecommunications distribution point with several such junction modules segregated from the line side of the distribution point. This retains the advantages of the line side being segregated from the backbone side, unlike known multiple junction blocks. More particularly line and backbone patching now has added flexibility, although the junction module in accordance with the invention satisfies all backbone requirements of the distribution point. The sum savings in size due to the plurality of junction modules employed can be effectively exploited to reduce the space needed at the backbone side, whereby overvoltage protection can be provided to advantage at the line side of each junction module. As aforementioned the backbone contact elements of the junction module in accordance with the invention are provided as through-contacts with no overvoltage tap. Instead the overvoltage tap is provided on the line side in each case so that protection occurs to a certain extent at a point “remote” from the distribution point and the backbone side is kept free of overvoltage protection means.

Furthermore since the backbone junction modules can now be prefabricated in the form of cable connectors, mounting components on the backbone side as required conventional is avoided. In conclusion, maintaining the segregation of the line side and backbone side offers the considerable advantage that the junction modules are segregated accordingly to the way in which they are adapted, for example, segregated between ISDN and analog, as well as depending on the scope of services provided, for example, segregating subscribers telephoning frequently and less frequently.

### BRIEF DESCRIPTION OF DRAWINGS

The invention will now be detained by way of an example with reference to the drawing in which:

FIG. 1 is a schematic view in perspective of a first embodiment of the junction module in accordance with the invention; and

FIG. 2 is a schematic view in perspective of a second embodiment of the junction module in accordance with the invention.

### DETAILLED DESCRIPTION OF PREFERRED EMBODIMENTS OF THE INVENTION

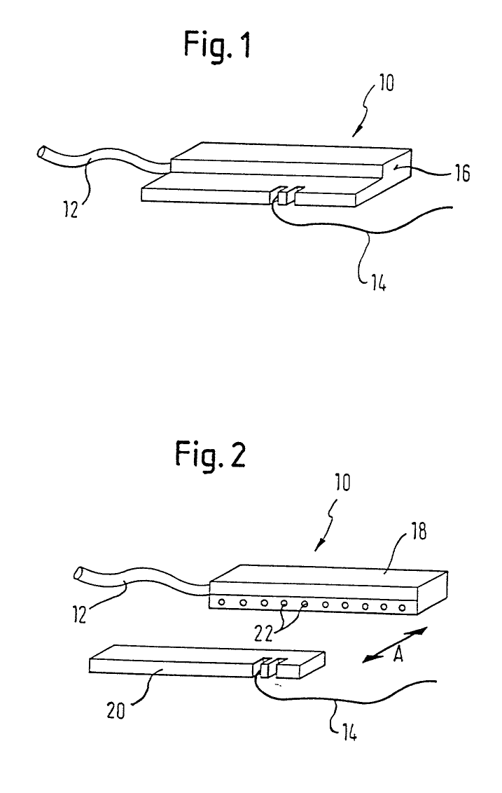

Referring now to FIG. 1 there is illustrated the junction module 10 in accordance with the invention in a one-part design. The junction module 10 is configured as a prefabricated cable connector to which the conductors of a backbone cable 12 can be joined in a rear portion in its mounting position. It is to be noted that the conductors of the backbone cable 12 may also be joined from one of the two sides, i.e. from the left or right as shown in FIG. 1 instead of the rear junction. In conclusion the junction module in accordance with the invention may be configured so that it comprises on all three of the cited sides a passage for the backbone cable so that deciding in which direction the backbone cable is to be led away from the junction module 10 can be put off until the junction of the conductors of the backbone cable is made.

In the example as shown through-contact elements lead from the rear portion to the front portion, to the IDC contacts of which patching cables 14 can be joined, only one of which is shown in the Figure. Located at the narrow side edges 16 of the junction module 10 are the means (not shown) for mounting the junction module 10 in a telecommunications rack-mounting system.

Referring now to FIG. 2 there is illustrated the junction module in accordance with the invention in a split design in which a cable junction portion 18 is segregated from a receiving portion 20. The same as in the embodiment as shown in FIG. 1 the conductors of the backbone cable 12 can be joined to the rear portion of the cable junction portion 18 in the mounting position, as a result of which the backbone cable 12 can be prefabricated with at least the cable junction portion 18 (with the complete cable connector in the embodiment as shown in FIG. 1) forming the junction module 10. In the embodiment as shown in FIG. 2 connecting the receiving portion 20 for joining the patching cables 14 is made via suitable contacts as indicated in the cable junction portion by the reference numeral 22. Mating the two components in the direction of the arrow A composes the junction module 10 in accordance with the invention.

The junction module may be furthermore provided with side wire guiding eyelets for the patching cables 14. As an alternative one of the horizontal surfaces may be provided with so-called wire guiding disks in which passages are provided for receiving the patching cables.

1. A telecommunications backbone junction module (10) in the form of a cable connector for mounting in a telecommunications rack-mounting system and comprising through-contact elements for joining the, particularly prefabricated, conductors of a backbone cable (12), on the one hand, and comprising, on the other, IDC contacts in a front portion in the mounting position for joining the patching cables (14).

2. The backbone junction module as set forth in claim 1 wherein it is configured split, one cable junction portion (18) being provided for joining the conductors of the backbone cable (132) connectable via suitable contacts (22) to a receiving portion (20) serving to join the patching cables (14).

3. The backbone junction module as set forth in claim 2 wherein the cable junction portion (18) is mountable in a telecommunications rack-mounting system.

4. A telecommunications distribution point including several backbone junction modules (10) as set forth in any of the preceding claims which are segregated from the line junction modules.
